(19) United States
(12) Patent Application Publication
(10) Pub. No.: US 2026/0065052 A1
(43) Pub. Date: Mar. 5, 2026

(54) SYSTEM AND METHOD FOR ARTIFICIAL INTELLIGENCE TRAINING AND COMPUTER-READABLE MEDIUM THEREOF

(71) Applicant: JETSPARQ TECHNOLOGY LTD., Taipei City (TW)

(72) Inventor: Hsiu-Chi CHANG, Taipei City (TW)

(73) Assignee: JETSPARQ TECHNOLOGY LTD., Taipei City (TW)

(21) Appl. No.: 19/316,358

(22) Filed: Sep. 2, 2025

Related U.S. Application Data
(60) Provisional application No. 63/689,970, filed on Sep. 3, 2024.

(51) Int. Cl. G06N 3/08; G06F 9/54; G06F 16/22; G06N 3/0475

(52) U.S. Cl. CPC G06N 3/08; G06F 9/543; G06F 16/2237; G06N 3/0475

(57) ABSTRACT

A system and a method for artificial intelligence training and a computer-readable medium thereof are provided. A back-end central control module invokes a large language model and obtains model parameters of a corresponding user to fine-tune the large language model, and the large language model provides corresponding response information based on input information of the user. A personalized vector database is configured to query the response information to obtain a query result. When it is determined that both the response information and the query result cannot respond to the user, the system prompts the user to provide a corresponding response, and further trains the large language model with the content of the response to further optimize the large language model.

### BACKGROUND

### 1. Technical Field

The present disclosure relates to a technology for training artificial intelligence, and more particularly, to a system and a method for artificial intelligence training, and a computer-readable medium thereof.

### 2. Description of Related Art

Artificial intelligence (AI) has emerged in recent years. AI technology can be applied to a wide range of fields to perform various functions, such as searching for data, translating speech and text, analyzing data, and providing recommendations. However, before AI technology can be applied, the AI model must first be trained. In other words, the AI model must be given a large amount of information to learn, so that it can accurately provide users with useful feedback when applied.

For AI models, especially generative AI models, such as large language models (LLMs), when training large language models, users had to upload confidential company or personal information to a third-party system before model training could proceed. This posed a risk of confidential information leakage. To avoid the aforementioned problems, users can choose to build their own local system for training, thereby avoiding the risk of confidential information leakage. However, the hardware cost of building a local system is very high and is beyond the reach of ordinary people. Even if users overcome the implementing costs and build artificial intelligence based on a large language model, if the large language model lacks training data or the questions asked are irrelevant to the field of the input data, the large language model will not be able to provide users with correct responses, let alone the accuracy or precision of the responses.

In view of the above problems, how to provide a generative AI system, especially one that can reduce the inconvenience of providing training data during AI model training and avoid the problem of confidentiality leakage or inability to popularize caused by conventional AI model training, will become a goal that people in this technical field are eager to pursue.

### SUMMARY

In order to solve the above problems of the prior art, the present disclosure discloses an artificial intelligence training system, which comprises: a back-end central control module including an application program interface (API) unit for invoking a large language model and fine-tuning the large language model based on model parameters corresponding to a user, wherein upon receiving input information of the user, the API unit uses the fine-tuned large language model to analyze the input information to generate response information; and a personalized vector database connected to the API unit and querying according to the response information to generate a query result, wherein when the API unit determines that the response information is irrelevant to the input information and the query result is no relevant query result, the API unit prompts the user to provide corresponding information based on the input information, and uses the corresponding information provided by the user to train the large language model.

In one embodiment, the API unit modifies the model parameters based on the large language model trained with the corresponding information.

In one embodiment, the personalized vector database is a retrieval-augmented generation database.

In one embodiment, the present disclosure further comprises: a large language model module connected to the back-end central control module and having the large language model invoked by the API unit; and a personalized model storage database connected to the back-end central control module and configured to store the model parameters of the user.

In one embodiment, the present disclosure further comprises: a user interface connected to the back-end central control module and configured for the user to provide the input information and upload training data, wherein the back-end central control module further comprises a model training unit that trains the large language model using the training data to generate the model parameters corresponding to the user.

In one embodiment, the present disclosure further comprises: a graphics processing unit module connected to the back-end central control module and providing data calculations during model training.

In one embodiment, the graphics processing unit module includes a ground-based graphics processing unit server or a cloud-based graphics processing unit server.

The present disclosure further discloses an artificial intelligence training method performed on a computer device or a server and comprising: receiving input information of a user by a back-end central control module, wherein the back-end central control module includes an application program interface (API) unit; invoking, by the API unit, a large language model and fine-tuning the large language model based on model parameters corresponding to the user; using, by the API unit, the fine-tuned large language model to analyze the input information to generate response information; querying, by a personalized vector database, according to the response information to generate a query result; prompting, by the API unit, the user to provide corresponding information based on the input information when the API unit determines that the response information is irrelevant to the input information and the query result is no relevant query result; and training the large language model with the corresponding information provided by the user.

In one embodiment, the present disclosure further comprises: modifying, by the API unit, the model parameters based on the large language model trained with the corresponding information.

In one embodiment, the personalized vector database is a retrieval-augmented generation database.

In one embodiment, the API unit invokes the large language model from a large language model module having the large language model, and obtains the model parameters from the personalized model storage database storing the model parameters of the user, so as to fine-tune the large language model according to the model parameters corresponding to the user.

In one embodiment, the back-end central control module is configured to receive the input information of the user via a user interface for the user to provide the input information and upload training data.

In one embodiment, uploading the training data comprises following steps: dividing, by the large language model, text blocks of the training data into blocks; generating, by the large language model, corresponding questions based on each of the text blocks; and generating, by the large language model, a corresponding question set for each of the questions.

In one embodiment, the back-end central control module further comprises a model training unit, and the model training unit uses the training data to train the large language model to generate the model parameters corresponding to the user.

In one embodiment, the model training unit is connected to a graphics processing unit module, and the graphics processing unit module provides data calculations when the model training unit performs model training.

In one embodiment, the graphics processing unit module includes a ground-based graphics processing unit server or a cloud-based graphics processing unit server.

The present disclosure further discloses a computer-readable medium used in a computing device or a computer and storing instructions for executing the aforementioned artificial intelligence training method.

As can be seen from the above, in the artificial intelligence training system, the artificial intelligence training method and the computer-readable medium of the present disclosure, when the large language model and the personalized vector database are unable to provide the user with an accurate response, the user can reply with corresponding information based on the prompt and use it to train the large language model, thereby achieving the purpose of improving the response accuracy of the large language model.

### BRIEF DESCRIPTION OF THE DRAWINGS

FIG. 1 is a system architecture view of an artificial intelligence training system according to a first embodiment of the present disclosure.

FIG. 2 is a system architecture view of an artificial intelligence training system according to a second embodiment of the present disclosure.

FIG. 3 is a flowchart of steps of an artificial intelligence training method according to the present disclosure.

FIG. 4 is a flowchart of steps of uploading training data according to the present disclosure.

### DETAILED DESCRIPTION

The following describes the embodiments of the present disclosure with examples. Those skilled in the art can easily understand other advantages and effects of the present disclosure from the contents disclosed in this specification. However, the present disclosure may also be implemented or applied via other different specific embodiments.

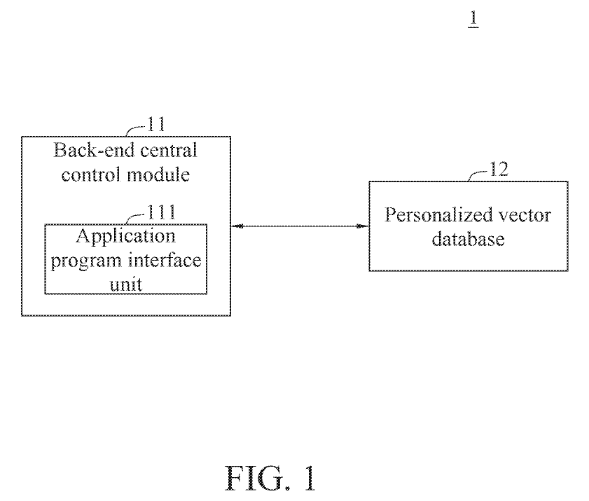

FIG. 1 is a system architecture view of an artificial intelligence training system according to a first embodiment of the present disclosure. As shown, the artificial intelligence training system 1 according to the present disclosure includes a back-end central control module 11 and a personalized vector database 12. A detailed description of the artificial intelligence training system 1 according to the present disclosure is provided below.

The back-end central control module 11 includes an application program interface (API) unit 111, wherein the API unit 111 is configured to invoke a large language model (LLM). Specifically, the large language model can be stored in the system of the present disclosure or downloaded from the cloud, and the large language model invoked may be one that has not undergone personalized training by the user. In addition, the API unit 111 can invoke model parameters corresponding to the user. That is, the user can use the training data to perform personalized training on the large language model, so that the large language model generates the model parameters corresponding to the user. The model parameters can be stored in the system of the present disclosure, so that when the API unit 111 receives a user's usage request, the API unit 111 can read the corresponding model parameters according to the user's identity (such as account and password) and fine-tune the large language model according to the model parameters corresponding to the user to personalize the large language model. Accordingly, after the API unit 111 receives input information from the user (such as asking questions or chatting with the system of the present disclosure), the API unit 111 uses the fine-tuned large language model to analyze the input information and generate response information.

The personalized vector database 12 is connected to the API unit 111 and can query the response information generated by the API unit 111 in response to the input information to generate a query result. The personalized vector database 12 then returns the query result to the API unit 111, and the API unit 111 can then decide whether to respond to the user with the response information or the query result. In one embodiment, the personalized vector database 12 is a retrieval-augmented generation (RAG) vector database.

Specifically, when the large language model and the RAG vector database work together, the large language model is responsible for understanding the input information and generating corresponding response information, while the RAG vector database is responsible for fact retrieval and verification, that is, the results generated by the large language model are retrieved and verified. Furthermore, the system of the present disclosure provides creative responses via a large language model, that is, provides corresponding response information generated as described above, and provides accuracy assurance after fact retrieval and verification by the RAG vector database, thereby having a complementary mechanism. Therefore, the purpose of ensuring accuracy can be achieved. In addition, the system of the present disclosure dynamically selects a dominant approach based on the characteristics of the questions and the quality of the responses in the input information, that is, it selects to execute the aforementioned collaborative work or activate the complementary mechanism. Furthermore, the present disclosure uses the responses generated by the large language model as semantic clues for querying or searching the RAG vector database, and then uses the search results of the RAG vector database as training data for the large language model, thereby having the effect of a learning feedback loop. Therefore, the performance of the large language model and the RAG vector database influence each other and evolve together, thus achieving the goal of two-way optimization.

For example, in the large language model priority mode, if a user enters "How is the weather today?", the large language model will generate a weather-related response (high relevance), and, after the RAG vector database either skips querying or performs a corresponding auxiliary verification query, the final output decision will primarily adopt the response of the large language model. For another example, in the RAG vector database rescue mode, if a user enters "What is our company's leave policy?", the large language model will generate a generic response (low relevance). The RAG vector database will then query "search company policy documents." The final output will be based on the results of the RAG vector database, and refined by the large language model. For another example, in the learning trigger mode, if a user enters "What are the technical specifications of the new product XYZ?", the large language model will respond with "I don't know" (low relevance). After searching the RAG vector database and finding no relevant documents, the system of the present disclosure will execute "requesting the user to provide information" to the user to update the RAG vector database and fine-tune the learning process of the large language model based on the provided information.

Furthermore, when the API unit 111 determines that the response information is irrelevant to the input information (or has no real source) and the query result is unrelated (i.e., there are no results similar to the input information), it prompts the user to provide corresponding information based on the input information, and uses the corresponding information provided by the user to train the large language model. More specifically, the API unit 111 of the present disclosure has an allocation mechanism, that is, a self-censorship mechanism when responding to the input information of the user (e.g., questions asked by the user). Specifically, the system of the present disclosure will compare the reply content of the response information with the data in the personalized vector database 12 (for example, RAG data). If it is determined that the output response information has no real source, it will use the RAG data instead and regenerate another response information. Furthermore, if no answer similar to the input information can be found in the personalized vector database 12, the user will be prompted to inform that the section of the input information requires human intervention to provide a corresponding answer. That is, the user is required to provide the correct corresponding information, and after the user provides the corresponding information, the corresponding information is used to train the large language model. Thus, the purpose of optimizing the large language model can be achieved, so that the API unit 111 can accurately and correctly respond to the user's question when the user asks a similar question next time. Thereafter, the API unit 111 modifies the model parameters based on the large language model as trained with the corresponding information.

In one embodiment, the API unit 111 has an intelligent allocation mechanism. Specifically, the API unit 111 includes a response quality evaluator and an evidence verifier (not shown). After receiving the user's input information, the API unit 111 first generates initial response information using the fine-tuned large language model, and then the response quality evaluator calculates the semantic relevance score between the response information and the input information. If the relevance score is lower than a first preset threshold, the response information is determined to be unrelated to the input information. The evidence verifier performs a similarity query on the key concepts in the response information in the personalized vector database 12. If the highest similarity score of the query result is lower than a second preset threshold, the response information is determined to have no real source. When both of the above conditions are met (i.e., the relevance score is lower than the first preset threshold [condition 1], and the highest similarity score is lower than the second preset threshold [condition 2]), the API unit 111 prompts the user to provide corresponding information based on the input information, and uses the corresponding information of the user to train the large language model. In addition, if only condition 1 is satisfied but condition 2 is not satisfied, the API unit 111 uses the query result of the personalized vector database 12 in combination with the large language model to regenerate response information.

In other words, when the user provides correct corresponding information, the system of the present disclosure will further set corresponding parameters, that is, parameters used to adjust the creativity outputted by the large language model, wherein the system of the present disclosure uses a prompt of the user's reply process to the corresponding information as a parameter of the API unit 111 to serve as a control item for AI-generated content. In addition, the system of the present disclosure can use the personalized vector database 12 to store the files uploaded by the user to improve the accuracy of the AI response, so that when the user enters the system of the present disclosure again, the system of the present disclosure will automatically load the corresponding fine-tuned model parameters for setting. Thereafter, the user starts to talk to the AI, and the API unit 111 will use the personalized RAG vector database and the large language model to generate a response corresponding to the conversation and reply to the user.

In other words, when the user provides correct corresponding information, the system of the present disclosure further performs a personalized model optimization process. Specifically, the API unit 111 will analyze the characteristics of the corresponding information provided by the user and adjust the personalized model parameters accordingly. The method is as follows.

A step of adjusting response control parameters is executed. The system of the present disclosure adjusts the creativity parameter, certainty parameter, and expertise parameter of the large language model based on user preferences, wherein the creativity parameter controls the degree of randomness in the model's response generation, the certainty parameter controls the rigor of responses to factual questions, and the expertise parameter adjusts the tendency to use specialized terminology.

A step of parameterizing a prompt template is executed. The system of the present disclosure converts the user interaction pattern into a structured prompt template. Specific steps include parameterizing and storing characteristics such as response format, level of detail, and citation method as a control basis for AI content generation.

A personalized knowledge base integration step is executed. The system of the present disclosure utilizes the personalized vector database 12 to store the files uploaded by the user and the accumulated knowledge, and creates a knowledge graph that includes relevance weights, timeliness tags, and credibility scores to improve the accuracy of AI responses.

A step of dynamically loading a system is executed. When the user re-enters the system, the API unit 111 automatically loads the corresponding fine-tuning model parameters, prompt template parameters, and personalized threshold settings.

An intelligent collaborative response step is executed. The system of the present disclosure determines the response strategy based on the characteristics of the question, wherein factual queries prioritize using the RAG vector database for retrieval, creative questions rely on fine-tuning the large language model, and hybrid questions combine the advantages of both.

In summary, the system of the present disclosure can achieve the goal of ensuring that each conversation provides a personalized response that meets the user's preferences and is supported by reliable sources.

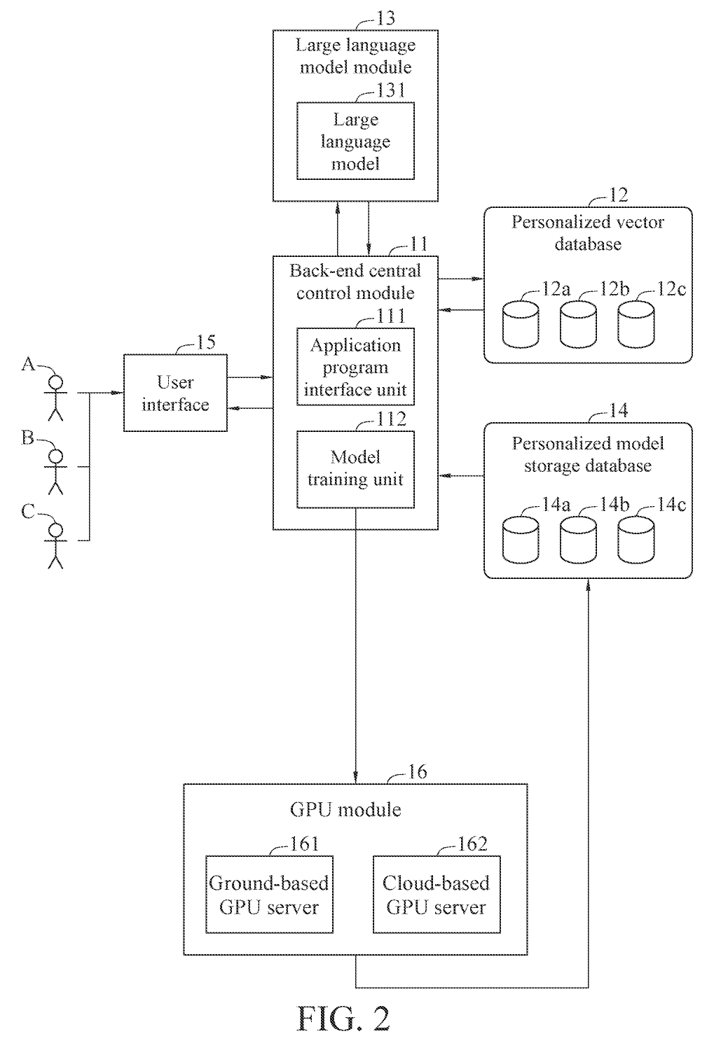

FIG. 2 is a system architecture view of an artificial intelligence training system according to a second embodiment of the present disclosure. As shown in the figure, the artificial intelligence training system 1 according to the present disclosure further comprises a large language model module 13, a personalized model storage database 14, a user interface 15, and a graphics processing unit module 16, as described below.

The large language model module 13 is connected to the back-end central control module 11 and has a large language model 131 for the API unit 111 to invoke to add model parameters for fine-tuning. That is, in one embodiment, the large language model 131 is stored in the large language model module 13, and the large language model module 13 can perform model updates regularly. In one embodiment, the large language model 131 may be Meta LLAMA233B, LLAMA270B, or LLAMA370B, and Fine-Tune is added, specifically using parameters of Low-Rank Adaptation (LoRA) or Quantized LoRA (QLoRA) technology.

The personalized model storage database 14 is connected to the back-end central control module 11 and is configured to store the model parameters for each user. In one embodiment, the artificial intelligence training system 1 of the present disclosure can be used by multiple users A, B, and C, wherein different user accounts are provided for identification. Accordingly, the personalized model storage database 14 provides separate model parameter storage for each user account. In other words, the parameters of each user account do not interfere with each other and are stored only in parameter data storage blocks 14a, 14b, and 14c corresponding to that user account. When a user wishes to obtain his or her own unique training model, the system of the present disclosure first clears the training data and downloads the adaptive parameters of Fine-Tune to fine-tune the large language model.

When a user logs into the system of the present disclosure, the system identifies the user and his or her corresponding model parameters (or fine-tuning parameters). When the application program interface unit invokes the large language model, the system specifies the corresponding model parameters and fine-tunes the large language model. This allows the user to utilize his or her unique large language model to perform functions such as searching files, writing reports, comparing documents, translating documents, or creating marketing proposals.

In addition, the personalized vector database 12 can also provide training data storage blocks 12a, 12b, and 12c corresponding to different users A, B, and C, respectively, to store the user's training data for training the large language model 131, or store relevant information responded to by the user according to the prompt.

The user interface 15 is connected to the back-end central control module 11, so that if the user submits the input information and uploads the training data, the input information and the training data will be transmitted to the API unit 111 and stored in separate storage blocks in the personalized vector database 12.

Furthermore, the back-end central control module 11 further includes a model training unit 112. When each user A, B, C uploads training data through the user interface 15, the model training unit 112 trains the large language model 131 based on the training data. The model parameters corresponding to the users A, B, and C are generated accordingly and stored in the parameter data storage blocks 14a, 14b, and 14c of the personalized model storage database 14, respectively, and are associated with and encrypted to the user's account.

Furthermore, the system of the present disclosure may further include a graphics processing unit module 16 connected to the back-end central control module 11 to provide data calculations when the system trains a large language model. In one embodiment, the graphics processing unit module 16 includes a ground-based graphics processing unit (GPU) server 161 or a cloud-based graphics processing unit server 162.

When training a model, a ground-based graphics processing unit server or a cloud-based graphics processing unit server can be selected to serve as the training method. After the training is complete, the parameters are stored in the corresponding parameter data storage blocks 14a, 14b, and 14c of the personalized model storage database based on the user account, so as to ensure that the parameters do not interfere with each other. For example, when user A invokes the large language model via the API unit 111, the system will only use the trained model parameters corresponding to user A; and when user B invokes the model API, the trained model parameters corresponding to user B will be used.

In summary, the back-end central control module 11 of the present disclosure incorporates a modulation mechanism. At the beginning of use, the user does not need to use a trained large language module, but can directly use the RAG vector database to retrieve the required data. However, during the use, the user may encounter questions that the RAG vector database cannot answer, or receive responses that are irrelevant to the user's query. In this case, the user interface provides an intelligent annotation interface that allows the user to perform multi-dimensional annotation to create a vocabulary library or items to be adjusted. Specifically, multi-dimensional annotation includes functions such as adding keyword annotation, synonym correspondence annotation, question classification annotation, inappropriate response reason annotation, expected response format annotation, and correct answer provision to expand the vocabulary library or create a list of items to be adjusted. However, because the RAG mechanism can already handle most (e.g., over 90%) of the problems, the system communicates with the model training unit 112 via the API unit 111. The system of the present disclosure utilizes a hybrid training approach, combining online and offline training. Online training is responsible for real-time updating of the RAG vector database, adjusting prompt templates, and learning user preferences, while offline training periodically fine-tunes the model, rebuilds the knowledge graph, and optimizes system performance. Furthermore, the system of the present disclosure provides user-controlled options for manual or periodic updates. When the accumulated vocabulary library and items to be adjusted meet pre-set conditions, an offline training process is intelligently triggered. Therefore, the system of the present disclosure enables manual and/or periodic updates and provides user-controlled options for periodically converting the vocabulary library and items to be adjusted into training data. In summary, the AI training system of the present disclosure does not simply train models using offline methods based on different clients' training data. Instead, it employs a two-layer hybrid training approach that combines real-time response and deep learning. It utilizes the RAG vector database to provide clients with fast database retrieval capabilities. Data currently not in the database can be manually added via the intelligent annotation interface of the system, thereby enabling the system to aggregate and organize the data into the next round of training data.

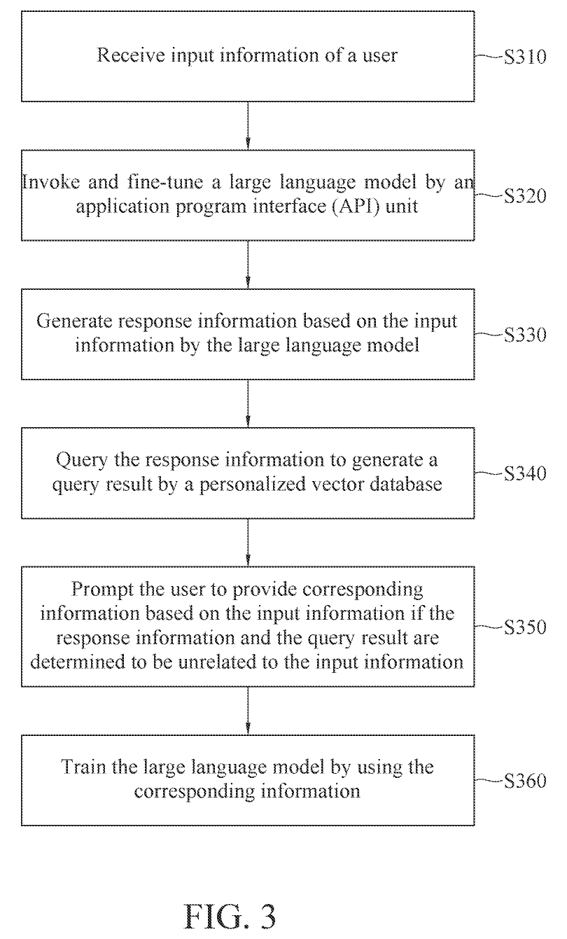

FIG. 3 is a flowchart of steps of an artificial intelligence training method according to the present disclosure. The artificial intelligence training method of the present disclosure is executed by a computer device. In one embodiment, the method is executed via the artificial intelligence training system described above. Therefore, the description of the artificial intelligence training system is provided above and is not restated here. The method of the present disclosure includes the following steps.

In step S310, input information of a user is received. The back-end central control module receives the input information of the user, wherein the input information may be a question posed by the user or the content of a chat with the AI. In addition, the back-end central control module includes an application program interface (API) unit.

In one embodiment, the back-end central control module receives the user's input information via a user interface for the user to submit the input information and upload training data. The steps related to uploading training data are described in another paragraph.

In step S320, the API unit invokes the large language model. The API unit invokes the large language model and the model parameters corresponding to the user to fine-tune the large language model based on the model parameters in order to personalize the large language model, so that the large language model can more accurately respond to the user's questions or chat content.

In one embodiment, the API unit invokes a large language model from a large language model module that has the large language model, and obtains model parameters from a personalized model storage database that stores the model parameters for the user. That is, the large language model can be pre-stored in the large language model module, or when needed, the most recent large language model can be downloaded from the network and stored in the large language model module. Furthermore, the large language model module can be configured to periodically download or update the latest large language model.

In step S330, the large language model generates response information based on the input information. The API unit generates response information corresponding to the input information of the user using the fine-tuned large language model. That is, after the large language model is fine-tuned, the response information can be provided for the input information to prepare a response to the user.

In step S340, the personalized vector database queries the response information to generate a query result. The personalized vector database is queried according to the response information to generate a query result. In one embodiment, the response information may be generated in the API unit. First, whether the response information has a corresponding source or is relevant to the input information of the user is determined. If the response information has no corresponding source or is unrelated to the input information, the large language model cannot respond to the input information of the user. At this time, the API unit transmits the response information to the personalized vector database for query to obtain the query result. In another embodiment, when the API unit generates the response information, the personalized vector database may be requested to query the response information and generate the corresponding query result.

In step S350, if the response information and the query result are determined to be unrelated to the input information, the user is prompted to provide corresponding information based on the input information. If the API unit determines that the response information is unrelated to the input information and the query result is unrelated query result, the user is prompted to provide corresponding information based on the input information by issuing a prompt.

In step S360, the large language model is trained using the corresponding information. When the user provides corresponding information that correctly responds to the prompt, the corresponding information is used to train the large language model. Furthermore, after the large language model is trained with the corresponding information, the API unit modifies the model parameters based on the large language model trained with the corresponding information to optimize the model parameters, so that the large language model can respond more accurately when the user interacts with the large language model again.

Accordingly, the large language model uses the corresponding information provided by the user in response to the prompt as training data to perform model training. Based on this, the method of the present disclosure can achieve the purpose of optimizing the large language model and can achieve the purpose of enabling the large language model to accurately provide the user with the correct response. In addition, after the large language model generates response information, the method of the present disclosure performs an online query via the RAG mechanism, and the user provides corresponding data in an offline manner, and uses the data to train the modulation mechanism of the large language model, so that the large language model can respond to the user more accurately when the user asks again.

In one embodiment, the back-end central control module further comprises a model training unit. The model training unit trains the large language model using the training data to generate model parameters corresponding to the user. The training data may be training data uploaded by the user via the user interface or corresponding data corresponding to a prompt.

Furthermore, the model training unit can be connected to a graphics processing unit (GPU) module, so that data calculations is provided by the GPU module when the model training unit performs model training. In one embodiment, the GPU module includes a ground-based graphics processing unit server or a cloud-based graphics processing unit server.

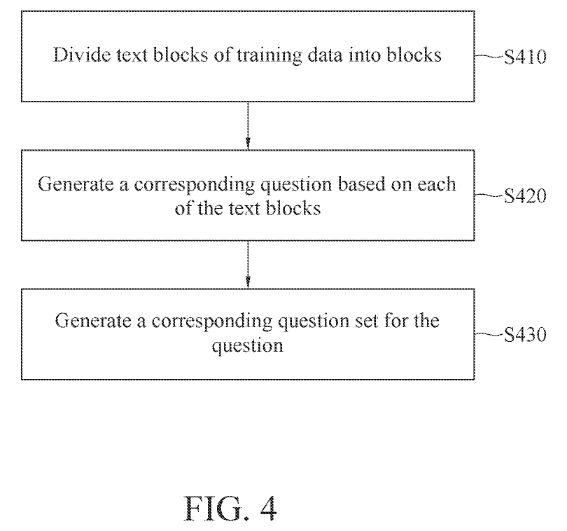

FIG. 4 is a flowchart of steps for uploading training data according to the present disclosure. As shown in the figure, the steps for uploading training data according to the present disclosure include the following steps.

In step S410, text blocks of the training data are divided into blocks. The large language model is configured to divide the text blocks of the training data into blocks, thereby dividing the training data into a plurality of blocks.

In step S420, a corresponding question is generated based on each text block. The large language model generates a corresponding question based on each text block.

In step S430, a corresponding question set is generated for the question. The large language model generates a corresponding question set for the question.

Accordingly, by dividing the uploaded training data into text blocks, corresponding questions are generated for each block. Multiple questions are then generated based on the generated questions using different query methods to form a question set. This avoids the problem of insufficient uploaded training data. In addition, dividing the training data into text blocks solves various problems, for example, data uploaded by the user is unstructured data or cannot be used for model training due to the lack of defined attributes.

For example, the uploaded training data asks, “Is registration required when a patent right changes?” The answer is, “A patent right is an intangible property right that can be assigned, inherited, entrusted, authorized to others to implement, or pledged. A change in a patent right takes effect when both parties agree. However, to be effective against third parties, it must be registered with the Intellectual Property Office. The date of registration approval shall prevail.” Five different question types were added to the question, including, “Is registration required when a patent right changes?”, “Is registration required when a patent right is altered?", "Is registration required when a patent right is transferred or altered?”, “Is registration required to proceed when a patent right is changed?”, and “Is registration required when a patent right is varied?” The above five different questions all have the same answer, thereby avoiding the problem of insufficient uploaded training data, which results in an inability to fine-tune the model.

In addition, the present disclosure also provides a computer-readable medium, which is used in a computing device or computer having a processor (for example, a central processing unit [CPU], a GPU, and the like) and/or a memory. The computer-readable medium stores instructions, and the computer-readable medium can be executed by a computing device or a computer via a processor and/or a memory, so as to execute the above method, steps or processes when executing the computer-readable medium. In one embodiment, the computer-readable medium is a non-transitory computer-readable storage medium.

The modules, units, devices, etc. of the present disclosure include a microprocessor and a memory, and algorithms, data, programs, and the like are stored in the memory or on a chip. The microprocessor can load data, algorithms, or programs from the memory to perform data analysis or calculations, which will not be described in detail here. In other words, the artificial intelligence training system and method of the present disclosure can be executed on electronic devices, such as general computers, tablets, or servers, to perform analysis and calculations after obtaining data. Therefore, the system and method for estimating road traffic flow by combining mobile signaling and statistical data can be designed and constructed on electronic devices with processors, memory and other elements via software to run on various electronic devices. In addition, each module of the system and method for estimating road traffic flow by combining mobile signaling and statistical data can be composed of independent elements, such as a calculator, memory, storage, or firmware with a processing unit, or can be presented in the form of software, hardware, or firmware architecture, all of which can realize the present disclosure.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection with regard to the present disclosure should be as defined in the accompanying claims listed below.

What is claimed is:

1. An artificial intelligence training system, comprising:
a back-end central control module including an application program interface (API) unit for invoking a large language model and fine-tuning the large language model based on model parameters corresponding to a user, wherein upon receiving input information of the user, the API unit uses the fine-tuned large language model to analyze the input information to generate response information; and
a personalized vector database connected to the API unit and querying according to the response information to generate a query result,
wherein when the API unit determines that the response information is irrelevant to the input information and the query result is no relevant query result, the API unit prompts the user to provide corresponding information based on the input information, and uses the corresponding information provided by the user to train the large language model.

2. The artificial intelligence training system of claim 1, wherein the API unit modifies the model parameters based on the large language model trained with the corresponding information.

3. The artificial intelligence training system of claim 1, wherein the personalized vector database is a retrieval-augmented generation database.

4. The artificial intelligence training system of claim 1, further comprising:
a large language model module connected to the back-end central control module and having the large language model invoked by the API unit; and
a personalized model storage database connected to the back-end central control module and configured to store the model parameters of the user.

5. The artificial intelligence training system of claim 4, further comprising: a user interface connected to the back-end central control module and configured for the user to provide the input information and upload training data, wherein the back-end central control module further comprises a model training unit that trains the large language model using the training data to generate the model parameters corresponding to the user.

6. The artificial intelligence training system of claim 1, further comprising: a graphics processing unit module connected to the back-end central control module and providing data calculations during model training.

7. The artificial intelligence training system of claim 6, wherein the graphics processing unit module includes a ground-based graphics processing unit server or a cloud-based graphics processing unit server.

8. An artificial intelligence training method, performed on a computer device or a server, comprising:
receiving input information of a user by a back-end central control module, wherein the back-end central control module includes an application program interface (API) unit;
invoking, by the API unit, a large language model and fine-tuning the large language model based on model parameters corresponding to the user;
using, by the API unit, the fine-tuned large language model to analyze the input information to generate response information;
querying, by a personalized vector database, according to the response information to generate a query result;
prompting, by the API unit, the user to provide corresponding information based on the input information when the API unit determines that the response information is irrelevant to the input information and the query result is no relevant query result; and
training the large language model with the corresponding information provided by the user.

9. The artificial intelligence training method of claim 8, further comprising: modifying, by the API unit, the model parameters based on the large language model trained with the corresponding information.

10. The artificial intelligence training method of claim 8, wherein the personalized vector database is a retrieval-augmented generation database.

11. The artificial intelligence training method of claim 8, wherein the API unit invokes the large language model from a large language model module having the large language model, and obtains the model parameters from the personalized model storage database storing the model parameters of the user, so as to fine-tune the large language model according to the model parameters corresponding to the user.

12. The artificial intelligence training method of claim 8, wherein the back-end central control module is configured to receive the input information of the user via a user interface for the user to provide the input information and upload training data.

13. The artificial intelligence training method of claim 12, wherein uploading the training data comprises following steps:
dividing, by the large language model, text blocks of the training data into blocks;
generating, by the large language model, corresponding questions based on each of the text blocks; and
generating, by the large language model, a corresponding question set for each of the questions.

14. The artificial intelligence training method of claim 12, wherein the back-end central control module further comprises a model training unit, and the model training unit uses the training data to train the large language model to generate the model parameters corresponding to the user.

15. The artificial intelligence training method of claim 14, wherein the model training unit is connected to a graphics processing unit module, and the graphics processing unit module provides data calculations when the model training unit performs model training.

16. The artificial intelligence training method of claim 15, wherein the graphics processing unit module includes a ground-based graphics processing unit server or a cloud-based graphics processing unit server.

17. A computer-readable medium, used in a computing device or a computer, storing instructions for executing the artificial intelligence training method of claim 8.
